(19) United States
(12) Patent Application Publication
(10) Pub. No.: US 2016/0335039 A1
(43) Pub. Date: Nov. 17, 2016

(54) MULTI DISPLAY SYSTEM AND OPERATION METHOD OF THE SAME

(71) Applicant: SAMSUNG ELECTRONICS CO., LTD., Suwon-si (KR)

(72) Inventors: Young-hoon CHO, Suwon-si (KR); Sang-kyun IM, Seoul (KR); Tae-hwan CHA, Yongin-si (KR)

(21) Appl. No.: 15/079,191

(22) Filed: Mar. 24, 2016

(30) Foreign Application Priority Data
May 13, 2015 (KR) 10-2015-0066945

(51) Int. Cl. G06F 3/14; G06T 3/40

(52) U.S. Cl. CPC G06F 3/1446; G06T 3/4092; G06F 3/1431

(57) ABSTRACT

A multi display system including a main display apparatus is provided. The main display apparatus includes: an input unit configured to receive an image signal; a processor configured to process the image signal to generate an image frame to be displayed on a multi display system including the main display apparatus and at least one sub display apparatus and to adjust a resolution of the image frame based on the number and resolutions of the at least one sub display apparatuses; an output unit configured to transmit the image frame having the adjusted resolution to the at least one sub display apparatus; and a display unit configured to display an area of the image frame having the adjusted resolution and corresponding to the main display apparatus.

### CROSS-REFERENCE TO RELATED APPLICATION

This application is based on and claims priority under 35 U.S.C. §119 to Korean Patent Application No. 10-2015-0066945, filed on May 13, 2015, in the Korean Intellectual Property Office, the disclosure of which is incorporated by reference herein in its entirety.

### BACKGROUND

1. Field

The present disclosure relates to methods and apparatuses for a multi display system and an operation method of the same.

2. Description of Related Art

A display apparatus is an apparatus having a function of displaying an image that a user may view. For example, an existing display apparatus performs a function of unidirectionally receiving a broadcast signal transmitted from a broadcasting station to display a broadcast image. However, a current display apparatus provides a function of outputting a broadcast image transmitted from a broadcasting station and various types of image contents.

Also, as a display apparatus is developed, the display apparatus is used as a video wall or the like that transmits advertisement and guide information in a situation control center of a police station, a fire station, a weather center, or the like, or in a shopping mall lobby or the like. Therefore, interests in a method of efficiently displaying an image through a plurality of display apparatuses have been increased together, but a large amount of energy and high cost are still problems.

### SUMMARY

Additional aspects will be set forth in part in the description which follows and, in part, will be apparent from the description.

According to an aspect of an example embodiment, a main display apparatus includes: communication circuitry configured to receive an image signal; a processor configured to process the image signal to generate an image frame to be displayed on a multi display system including the main display apparatus and at least one sub display apparatus and to adjust a resolution of the image frame based on the number and resolution of the at least one sub apparatuses, and to control the communication circuitry to transmit the image frame having the adjusted resolution to the at least one sub display apparatus; and a display configured to display an area of the image frame having the adjusted resolution and corresponding to the main display apparatus.

The processor may be configured to remove noise of the image frame having the adjusted resolution.

The processor may further include a decoder configured to decode the image signal. The processor may be configured to generate the image frame based on the decoded image signal.

The processor may be configured to generate a graphic user interface (GUI) image to be displayed on the main display apparatus and the at least one sub display apparatus and to combine the GUI image with the image frame.

The communication circuitry may be configured to transmit the image frame combined with the GUI image to the at least one sub display apparatus.

According to an aspect of another example embodiment, a sub display apparatus includes: communication circuitry configured to receive an image frame whose resolution is adjusted by a main display apparatus, the image frame to be displayed on a multi display system including the main display apparatus and at least one sub display apparatus, and to transmit the image frame having the adjusted resolution to another sub display apparatus of the multi display system; and a display configured to display an area of the image frame having the adjusted resolution corresponding to the sub display apparatus.

The sub display apparatus may further include an image quality adjuster, e.g., including adjustment circuitry, configured to adjust an image quality based on a characteristic of the display.

According to an aspect of another example embodiment, a main apparatus includes: communication circuitry configured to receive an image signal; and a processor configured to process the image signal to generate an image frame to be displayed on a multi display system including a plurality of external display apparatuses and to adjust a resolution of the image frame based on the number of external display apparatuses and resolutions of the plurality of external display apparatuses, and to control the communication circuitry to transmit the image frame having the adjusted resolution to at least one sub apparatus and to transmit an area of the image frame having the adjusted resolution and corresponding to an external display apparatus connected to the main apparatus to the external display apparatus connected to the main apparatus.

According to an aspect of another example embodiment, a sub apparatus includes: communication circuitry configured to receive an image frame whose resolution is adjusted by a main apparatus, the image frame to be displayed on a multi display system including a plurality of external display apparatuses, to transmit the image frame having the adjusted resolution to at least one other sub apparatus of the multi display system and to transmit an area of the image frame having the adjusted resolution and corresponding to an external display apparatus connected to the sub apparatus to the external display apparatus connected to the sub apparatus.

According to an aspect of another example embodiment, a multi display system includes: a main display apparatus configured to process an image signal to generate an image frame that will be displayed on the multi display system, to adjust a resolution of the image frame based on the number and resolutions of sub display apparatuses of the multi display system, to transmit the image frame having the adjusted resolution to at least one of the sub display apparatuses, and to display an area of the image frame having the adjusted resolution; and a plurality of sub display apparatuses configured to receive the image frame having the resolution adjusted by the main display apparatus and to display an area of the received image frame.

According to an aspect of another example embodiment, a display method of a main display apparatus, includes: processing an image signal to generate an image frame that will be displayed on a multi display system including the main display apparatus and at least one sub display apparatus; adjusting a resolution of the image frame based on the number and resolutions of the at least one sub display apparatuses; transmitting the image frame having the adjusted resolution to the at least one sub display apparatus; and displaying an area of the image frame having the adjusted resolution and corresponding to the main display apparatus on the main display apparatus.

The display method may further include removing noise of the image frame having the adjusted resolution.

The generating of the image frame may include: generating a GUI image to be displayed on the main display apparatus and the at least one sub display apparatus; and combining the GUI image with the image frame.

The transmitting of the image frame to the at least one sub display apparatus may include transmitting the image frame combined with the GUI image to the at least one sub display apparatus, and the displaying of the area of the image frame on the main display apparatus may include displaying the area of the image frame being combined with the GUI image and corresponding to the main display apparatus on a screen.

According to an aspect of another example embodiment, a display method of a sub display apparatus, includes: receiving an image frame having a resolution adjusted by a main display apparatus to enable the image frame to be displayed on a multi display system including the main display apparatus and at least one sub display apparatus; transmitting the image frame having the adjusted resolution to another sub display apparatus of the multi display system; and displaying an area of the image frame having the adjusted resolution and corresponding to the sub display apparatus to the sub display apparatus.

The display method may further include adjusting an image quality based on a characteristic of a display unit of the sub display apparatus.

According to an aspect of another example embodiment, an operation method of a main apparatus, includes: receiving an image signal; processing the image signal to generate an image frame that will be displayed on a multi display system comprising a plurality of external display apparatuses; adjusting a resolution of the image frame based on the number and resolutions of the plurality of external display apparatuses; transmitting the image frame having the adjusted resolution to at least one sub apparatus; and transmitting an area of the image frame having the adjusted resolution and corresponding to an external display apparatus connected to the main apparatus to the external display apparatus connected to the main apparatus.

According to an aspect of another example embodiment, an operation method of a sub apparatus, includes: receiving an image frame having a resolution adjusted by a main apparatus to enable the image frame to be displayed on a multi display system comprising a plurality of external display apparatuses; transmitting the image frame having the adjusted resolution to at least one another sub apparatus of the multi display system; and transmitting an area of the image frame having the adjusted resolution and corresponding to an external display apparatus connected to the sub apparatus to the external display apparatus connected to the sub apparatus.

### BRIEF DESCRIPTION OF THE DRAWINGS

These and/or other aspects will become apparent and more readily appreciated from the following detailed description, taken in conjunction with the accompanying drawings, in which like reference numerals refer to like elements, and wherein:

FIG. 1 is a block diagram illustrating an example multi display system;

FIG. 2 is a block diagram illustrating an example configuration of a processor of a main display apparatus;

FIGS. 3A and 3B are diagrams illustrating example selection of an area corresponding to each of display apparatuses configuring the multi display system;

FIG. 4 is a block diagram illustrating another example configuration of the processor of the main display apparatus;

FIG. 5 is a diagram illustrating an example operation of a main display apparatus;

FIG. 6 is a diagram illustrating an example operation of a multi display system;

FIG. 7 is a block diagram illustrating another example processor of a main display apparatus;

FIG. 8 is a diagram illustrating an example operation of an image combiner of a main display apparatus;

FIG. 9 is a diagram illustrating an example operation of a multi display system;

FIG. 10 is a block diagram illustrating an example configuration of a sub display;

FIG. 11 is a flowchart illustrating an example operation method of a main display apparatus;

FIG. 12 is a flowchart illustrating an example operation S1120 of FIG. 11;

FIG. 13 is a flowchart illustrating an example operation method of a sub display apparatus;

FIG. 14 is a flowchart illustrating an example operation method of a sub display apparatus;

FIG. 15 is a block diagram illustrating another example multi display system;

FIGS. 16A and 16B are diagrams illustrating an example connection between a main apparatus and an external display apparatus;

FIG. 17 is a flowchart illustrating an example operation method of a main apparatus; and

FIG. 18 is a flowchart illustrating an example operation method of a sub apparatus.

### DETAILED DESCRIPTION

Reference will now be made in greater detail to various embodiments, examples of which are illustrated in the accompanying drawings, wherein like reference numerals refer to like elements throughout. In this regard, the example embodiments may have different forms and should not be construed as being limited to the descriptions set forth herein. Accordingly, the example embodiments are merely described below, by referring to the figures, to explain aspects. As used herein, the term “and/or” may include any and all combinations of one or more of the associated listed items. Expressions such as “at least one of,” when preceding a list of elements, may modify the entire list of elements and does not necessarily modify the individual elements of the list.

The terms used herein will be described in brief, and the example embodiments will be described in greater detail.

The terms used herein are general terms that are currently widely used in consideration of functions in the example embodiments but may vary according to intentions of those of ordinary skill in the art, precedents, appearances of new technologies, or the like. Also, certain terms may be arbitrarily selected in a particular case, and meanings of the terms corresponding to this case will be described in detail in the description. There, the terms used here may be defined based on meanings thereof and the overall contents of the examples embodiments not necessarily based on names of simple terms.

When a part “comprises” an element in the description, this may mean that the part may not exclude and may further include other elements as long as there is no contrary description. The term “unit” or “module” used herein refers to a unit that processes at least one function or operation may be realized as hardware (e.g., circuitry), firmware or software or as a combination of hardware and software.

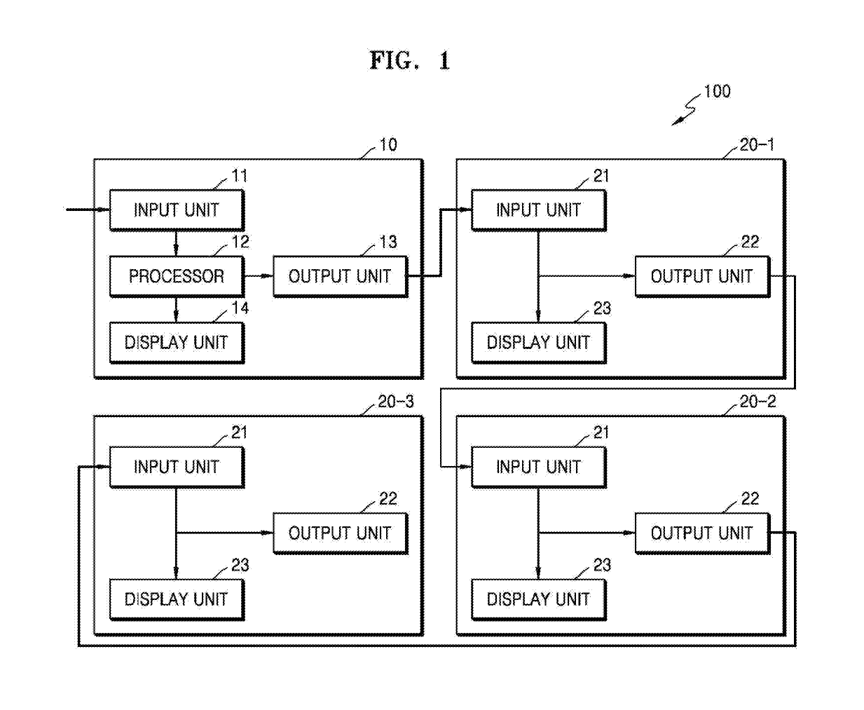

FIG. 1 is a block diagram illustrating an example multi display system 100. The multi display system 100 may include a plurality of display apparatuses that may output one image or a plurality of images.

Referring to FIG. 1, the multi display system 100 may include a main display apparatus 10 and a plurality of sub display apparatuses 20.

According to an example embodiment, the main display apparatus 10 may include communication circuitry which includes an input unit 11 and the output unit 13, a processor (e.g., including processing circuitry, such as, for example a CPU) 12, and a display unit (e.g., including a display panel, display driving circuitry, etc.) 14.

According to an example embodiment, the input unit 11 of the main display apparatus 10 may be configured to receive an image signal (or data) from an external source. For example, the image signal may include a voice signal. For example, the input unit 11 may receive an image signal from a broadcasting station, an image signal through an internet network, or the like. The input unit 11 may include various communication circuitry including, for example, a short-range communication module (e.g., a Wireless Local Area Network (LAN), Wi-Fi, Bluetooth, Near Field Communication (NFC), or the like), a wired communication module (e.g., pair cable, coaxial cable, optical fiber cable, or the like), a mobile communication module, or the like. A technology of the input unit 11 that receives an image signal through at least one communication module will be apparent to those of ordinary kill in the art and thus a detailed description thereof is omitted.

The input unit 11 may be configured to convert an image signal into a form that may be processed in the main display apparatus 10 (e.g., may convert an analog signal into a digital signal). The input unit 11 of the main display apparatus 10 may also be configured to provide the image signal to the processor 12.

According to an example embodiment, the image signal processed by the main display apparatus 10 may not be received from the input unit 11, but may be an image signal stored in the main display apparatus 10.

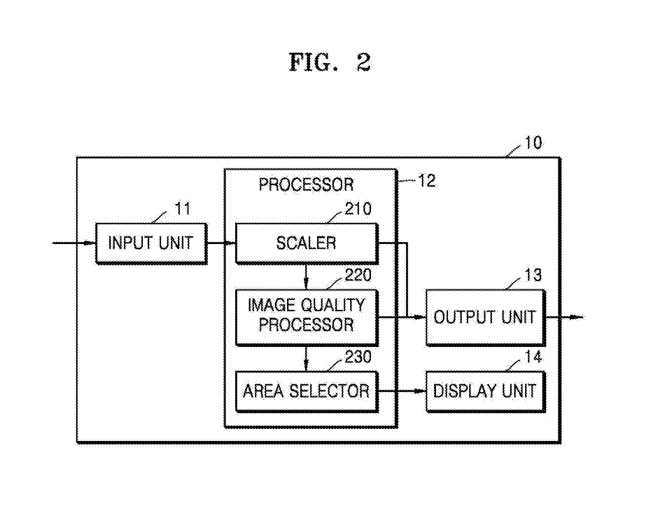

According to an example embodiment, the processor 12 of the main display apparatus 10 may be configured to process the received image signal to generate an image frame to be displayed on the multi display system 100. For example, the image frame may be a display data unit that is displayed on the main display apparatus 10 and sub display apparatuses 20-1 through 20-3 of the multi display system 100 for a preset time (e.g., for 0.2 seconds). For example, if each of display apparatuses included in the multi display system 100 displays an image in units of 30 frame per second (FPS), the main display apparatus 10 may generate 30 image frames per second. Also, the processor 12 may adjust a resolution of an image frame based on the number and resolutions of the sub display apparatuses 20. A method of adjusting a resolution of an image frame through the processor 12 will be described in greater detail below with reference to FIG. 2.

According to an example embodiment, the output unit 13 of the main display apparatus 10 may be configured to transmit the image frame having the adjusted resolution to at least one sub display apparatus 20. For example, as illustrated in FIG. 1, the output unit 13 of the main display apparatus 10 may transmit the image frame to the first sub display apparatus 20-1.

If the output unit 13 is separated from the input unit 11, the output unit 13 may also include its own elements for transmitting and receiving the image frame with at least one sub display apparatus 20. For example, the output unit 13 of the main display apparatus 10 may include at least one selected from a short-range communication module and a wired communication module, etc.

The display unit 14 of the main display apparatus 10 may be configured to display an area of the generated image frame corresponding to the main display apparatus 10.

The display unit 14 may also include a display panel (not shown) and a display controller (not shown) for driving the display panel. For example, the display unit 14 may display an area of the image frame processed in the main display apparatus 10 according to a Liquid Crystal Display (LCD) method, an Organic Light Emitting Diode (OLED) method, a Plasma Display Panel (PDP) method, or a Vacuum Fluorescent Display (VFD) method, or the like.

According to an example embodiment, the plurality of sub display apparatuses 20 configuring the multi display system 100 may include communication circuitry which includes input units 21 and output units 22, and display units (e.g., including a display panel) 23.

According to an example embodiment, the input unit 21 of the sub display apparatus 20 may be configured to receive the image frame generated by the main display apparatus 10. For example, as illustrated in FIG. 1, a first sub display apparatus 20-1 may receive the image frame from the main display apparatus 10, and a second sub display apparatus 20-2 may receive the image frame generated by the main display apparatus 10 from the first sub display apparatus 20-1, etc.

According to an example embodiment, the input unit 21 may receive the image frame having the resolution adjusted by the main display apparatus 10. Therefore, the sub display apparatus 20 may not necessarily include an image processing element such as the processor 12 of the main display apparatus 10.

The input unit 21 and the output unit 22 may also include communication circuitry including at least one selected from a short-range communication module (e.g., a Wireless LAN, Wi-Fi, Bluetooth, NFC, or the like) and a wired communication module (e.g., pair cable, coaxial cable, optical fiber cable, or the like). Alternatively, the input unit 21 may include only the wired communication module but is not limited thereto.

The input unit 21 may be configured to transmit the received image frame to the output unit 22 and the display unit 23 of the sub display apparatus 20.

According to an example embodiment, the output unit 22 of the sub display apparatus 20 may transmit the image frame, which is provided from the input unit 21, to another sub display apparatus. For example, as illustrated in FIG. 1, the first sub display apparatus 20-1 may transmit the image frame to the second sub display apparatus 20-2, and the second sub display apparatus 20-2 may transmit the image frame to a third sub display apparatus 20-3. For example, the image frame may be generated by the main display apparatus 10.

If the output unit 22 is separated from the input unit 21, the output unit 22 may include its own elements for transmitting and receiving the image frame with another sub display apparatus. For example, the output unit 22 may include communication circuitry including at least one selected from a short-range communication module and a wired communication module, or the like.

According to an example embodiment, the display unit 23 of the sub display apparatus 20 may display an area of the image frame, which is provided from the input unit 21, corresponding to the sub display apparatus 20. For example, the display units 23 of the first through third sub display apparatuses 20-1 through 20-3 may display areas of the image frame respectively corresponding to the first through third sub display apparatuses 20-1 through 20-3.

The display unit 23 may also include a display panel (not shown) and a display controller (not shown) for driving the display panel. For example, the display unit 23 may display an area of the image frame provided from the input unit 21 by using an LCD method, an OLED method, a PDP method, or a VFD method, or the like.

As described above, the first through third sub display apparatuses 20-1 through 20-3 according to an example embodiment may not necessarily include elements (e.g., the processor 12 of the main display apparatus 10) that display the image frame generated by the main display apparatus 10 to process an image signal in the sub display apparatus 20. Therefore, a cost for configuring the multi display system 100 may be reduced. Additionally, according to this example arrangement, the main display apparatus 10 and the plurality of sub display apparatuses 20 need not repeatedly process the image signal to enable the multi display system 100 thereby reducing a time taken for image-processing and a total amount of energy taken in the multi display system 100.

The main display apparatus 10 and the sub display apparatus 20 of FIG. 1 described above will now be described in greater detail below with reference to FIGS. 2 through 14.

FIG. 2 is a block diagram illustrating an example configuration of the processor 12 of the main display apparatus 10.

Referring to FIG. 2, the processor 12 of the main display apparatus 10 may include a scaler (e.g., including processing circuitry configured to provide a scaling function) 210, an image quality processor (e.g., including processing circuitry configured to provide an image quality processing function) 220, and an area selector (e.g., including processing circuitry configured to provide an area selection function) 230.

According to an example embodiment, the scaler 210 may be configured to generate an image frame that will be displayed on the multi display system 10, based on an image signal provided from or by the input unit 11.

According to an example embodiment, the scaler 210 may be configured to determine a resolution (hereinafter referred to as a target resolution) of the multi display system 100 based on the number and resolutions of the sub display apparatuses 20. For example, the number of sub display apparatuses 20 may be input by a user of the main display apparatus 10. In this example, the main display apparatus 10 may further include a user input unit (not shown). Alternatively, the number of sub display apparatuses 20 may be acquired or determined through a sensor included in a bezel of the main display apparatus 10. For example, the main display apparatus 10 may acquire the number of sub display apparatuses 20 through a proximity sensor, etc. included, for example, in left, right, upper, and lower sides of the bezel.

A resolution of the sub display apparatus 20 may be a resolution of a display panel of each of the sub display apparatuses 20. According to an example embodiment, the main display apparatus 10 may acquire the resolution of each of the sub display apparatuses 20 from each of the sub display apparatuses 20. Alternatively, the main display apparatus 10 may receive the resolution of each of the sub display apparatuses 20 from the user. For example, the resolutions of the sub display apparatuses 20 may be the same as one another.

A target resolution may be a resolution of an image frame provided through a screen of the main display apparatus 10 and a screen of the sub display apparatus 20. For example, if the number of sub display apparatuses 20 included in the multi display system 100 is 3, and each of the sub display apparatuses 20 has a resolution of 1920×1080, the scaler 210 may be configured to determine the target resolution as 3840×2160. Alternatively, if 8 sub display apparatuses 20 included in the multi display system 100 each have a resolution of 1280×720, the scaler 210 may be configured to determine the target resolution as 3840×2160.

The scaler 210 may be configured to generate an image frame having the determined resolution based on the image signal provided from the input unit 11. According to an example embodiment, the scaler 210 may be configured to perform up-scaling or down-scaling with respect to the image signal. For example, the scaler 210 may be configured to generate an image frame having a higher resolution than a resolution of the image signal through, for example, a nearest neighbor interpolation technique, a linear interpolation technique, a bipolar interpolation technique, a spine interpolation technique, a polynomial interpolation technique, or the like. The scaler 210 may also be configured to generate an image frame having a lower resolution than the resolution of the image signal through a blurring and sub-sampling technique, a median representation technique, or the like.

For example, if the resolution of the image signal provided from the input unit 11 is 1920×1080, and the target resolution (i.e., a resolution of the multi display system 100) is 3840×2160, the scaler 210 may be configured to perform up-scaling. Alternatively, if the resolution of the image signal provided from the input unit 11 is 3840×2160, and the target resolution is 3840×2160, the scaler 210 may be configured to not adjust the resolution.

According to an example embodiment, the scaler 210 may be configured to provide the generated image frame to the image quality processor 220. The scaler 210 may also be configured to provide an image fame, whose resolution is adjusted or whose resolution is not adjusted, to the output unit 13. The output unit 13 may transmit the received image frame to the sub display apparatus 20.

According to an example embodiment, the image quality processor 220 may be configured to perform image-quality processing such as, for example, a noise removing and/or reduction, contour processing, or the like, based on the image frame provided from the scaler 210. For example, the noise removing and/or reduction may include, for example, adjusting distorted data included in an image fame, and contour processing may include, for example clearing a contour of an object included in the image frame.

For example, the image quality processor 220 may be configured to perform Gaussian smoothing filtering, box smoothing, median filtering, or the like to remove and/or reduce noise included in the image frame. The image quality processor 220 may also be configured to perform a mask technique, a Laplacian of Gaussian (LoG) technique, a Canny edge extracting technique, or the like to perform contour processing. The image quality processor 220 may be configured to correct a boundary distortion phenomenon that may occur at an end point of the image frame but is not limited thereto. The image quality processor 220 may be configured to perform various types of processes to improve a quality of an image.

According to an example embodiment, the image quality processor 220 may be configured to provide an image frame, on which a process or processing is completed, to the output unit 13. The output unit 13 may be configured to transmit the image frame provided from the image quality processor 220 to the sub display apparatus 20.

The image quality processor 220 may be configured to provide the image frame, on which the processing is completed, to the area selector 230.

According to an example embodiment, the area selector 230 may be configured to select an area of the image frame, which is provided from the image quality processor 220, corresponding to the main display apparatus 10.

For example, the area selector 230 may be configured to select an area corresponding to the main display apparatus 10 based on a device number (e.g., number 1) pre-allocated to the main display apparatus 100 in the multi display system 100 or coordinate values (e.g., (0, 0)) preset to the main display apparatus 10 on the multi display system 100.

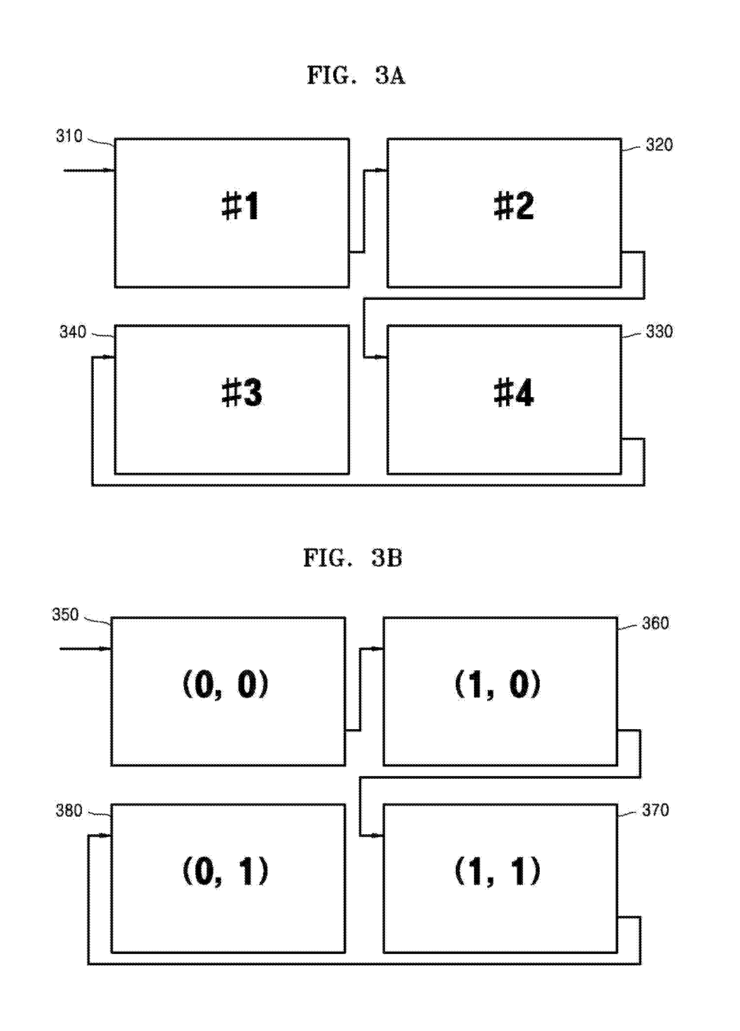

FIGS. 3A and 3B are diagrams illustrating example selections of areas respectively corresponding to display apparatuses configuring the multi display system 100.

Referring to FIG. 3A, the multi display system 100 may respectively allocate device numbers to the display apparatuses configuring the multi display system 100. For example, a user of the multi display system 100 may respectively allocate numbers 1 through 4 to display apparatuses 310 through 340 based on arrangement orders of the display apparatuses 310 through 340. The display apparatuses 310 through 340 included in the multi display system 100 may respectively select areas of an image frame based on pre-allocated device numbers.

Alternatively, as illustrated, for example, in FIG. 3B, the multi display system 100 may set coordinate values to display apparatuses 350 through 380 configuring the multi display system 100. The coordinate values may be automatically set by a user or by using sensors of display apparatuses. For example, if it is determined that another display apparatus is disposed on a left side of the display apparatus 360 using, for example, a proximity sensor included in a side bezel, the display apparatus 360 may acquire coordinate values of the another display apparatus disposed on the left side. For example, if the acquired coordinate values are (0, 0), a display apparatus may set coordinate values thereof to (0, 1). The display apparatuses 350 through 380 included in the multi display system 100 may respectively select areas of an image frame based on preset coordinate values.

Referring to FIG. 2, the area selector 230 may be configured to provide display data corresponding to a selected area to the display unit 14. The display unit 14 may display the display data provided from the area selector 230.

The term “processor” as illustrated and described in FIGS. 1 and 2 may include processing circuitry including, for example, a central processing unit (CPU) and a graphic processing unit (GPU). In this example, the processor may be referred to using various types or terms such as a controller, a processor, a video processor, an image processor, etc.

The term “processor” may include, for example, only the GPU. In this case, the processor may operate under control of an additional processor including the CPU.

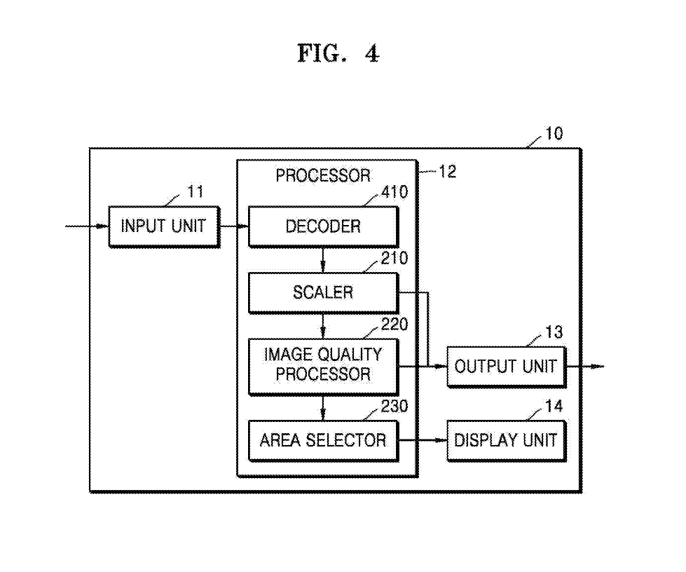

FIG. 4 is a block diagram illustrating an example configuration of the processor 12 of the main display apparatus 10.

Referring to FIG. 4, the processor 12 of the main display apparatus 10 may further include a decoder (e.g., including processing circuitry configured to provide a decoding function) 410 besides the scaler 210, the image quality processor 220, and the area selector 230.

According to an example embodiment, an image signal, which is provided from the input unit 11 of the main display apparatus 10 to the processor 12, may be in an encoded state. For example, the processor 12 may be provided with an encoded image signal from the input unit 11 through Moving Picture Experts Group-2 (MPEG-2), MPEG-4, MPEG-7, MPEG-21, CoreAVC, Xvid, H. 264 (MPEG-4 AVC), H.265 (High Efficiency Video Coding (HEVC)), or the like.

According to an example embodiment, the decoder 410 may be configured to decode the encoded image signal. The decoder 410 may be configured to determine an encoding method of the image signal provided from the input unit 11. The decoder 410 may also be configured to decode the image signal based on the determined encoding method.

The decoder 410 may be configured to transmit the decoded image signal to the scaler 210.

The scaler 210, the image quality processor 220, and the area selector 230 of FIG. 4 respectively correspond to the scaler 210, the image quality processor 220, and the area selector 230 of FIG. 2, and thus their detailed descriptions are omitted here.

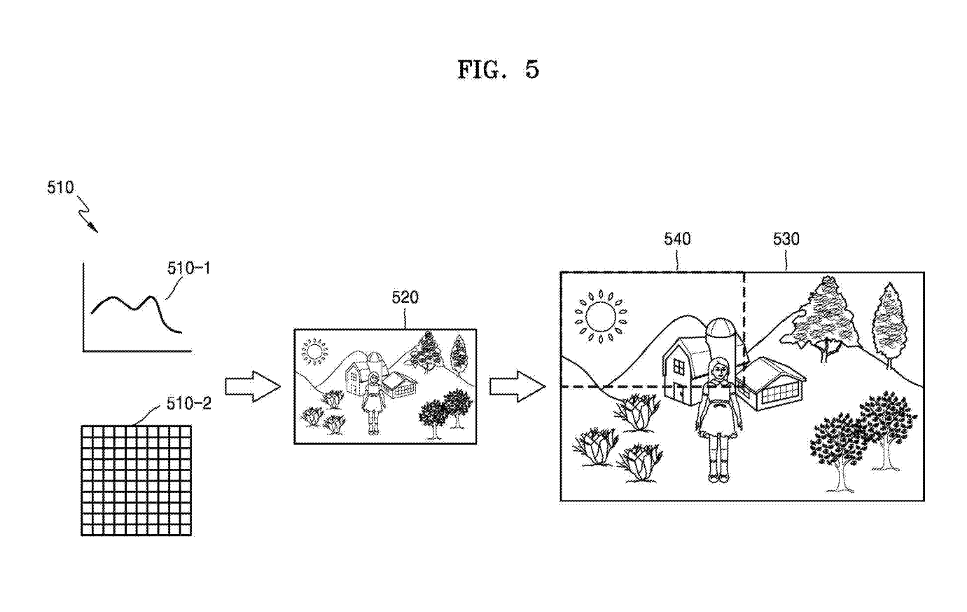

FIG. 5 is a diagram illustrating an example operation of the main display apparatus 10.

Referring to FIG. 5, the main display apparatus 10 may receive an image signal 510 from an external apparatus (e.g., a broadcasting station, a content provider, an external server, or the like). For example, the input unit 11 of the main display apparatus 10 may receive an analog image signal 510-1 from the broadcasting station or may receive an encoded image signal 510-2 through an internet network.

The main display apparatus 10 may convert the analog image signal 510-1 into a digital signal or may decode the encoded image signal 510-2.

The main display apparatus 10 may generate an image frame 530 that will be displayed on the multi display system 100, based on a converted or decoded image signal 520. For example, the main display apparatus 10 may adjust a resolution of the converted or encoded image signal 520 and perform image-quality processing.

The main display apparatus 10 may also transmit the generated image fame 530 to at least one sub display apparatus. For example, the image frame 530 transmitted to the sub display apparatus may be in an adjusted state. Alternatively, the image frame 530 may be in a state where noise removing and/or reduction processing is completed.

The main display apparatus 10 may display an area 540 of the image frame 530 corresponding to the main display apparatus 10 on a screen of the main display apparatus 10.

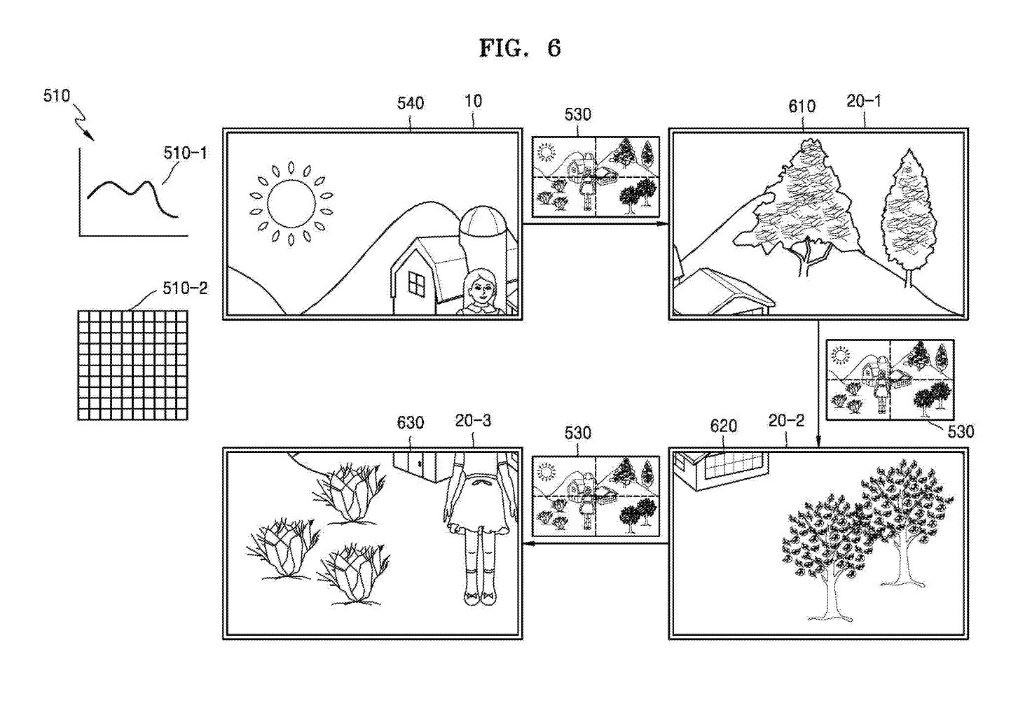

FIG. 6 is a diagram illustrating example operation of the multi display system 100.

Referring to FIG. 6, the main display apparatus 10 may transmit the image frame 530 generated in FIG. 5 to a first sub display apparatus 20-1. The main display apparatus 10 may also display an area 540 of the image frame 530 generated in FIG. 5 on a screen of the main display apparatus 10.

The first sub display apparatus 20-1 may transmit the image frame received from the main display apparatus 10 to a second sub display apparatus 20-2 and display an area 610 of the image frame 530 corresponding to the first sub display apparatus 20-1 on a screen of the first sub display apparatus 20-1.

A third sub display apparatus 20-3 may transmit the image frame 530 received from the second sub display apparatus 20-2 to the second sub display apparatus 20-2 and display an area 620 of the image frame 530 corresponding to the second sub display apparatus 20-2 on a screen of the second sub display apparatus 20-2.

Also, the third sub display apparatus 20-3 may display an area 630 of the image frame 530, which is received from the second sub display apparatus 20, corresponding to the third sub display apparatus 20-3 on a screen of the third sub display apparatus 20-3.

The main display apparatus 10 has been described as transmitting the image frame 530 to the first sub display apparatus 20-1 in FIG. 6 but is not limited thereto. For example, the main display apparatus 10 may transmit the image frame 530 to the first through third sub display apparatuses 20-1 through 20-3.

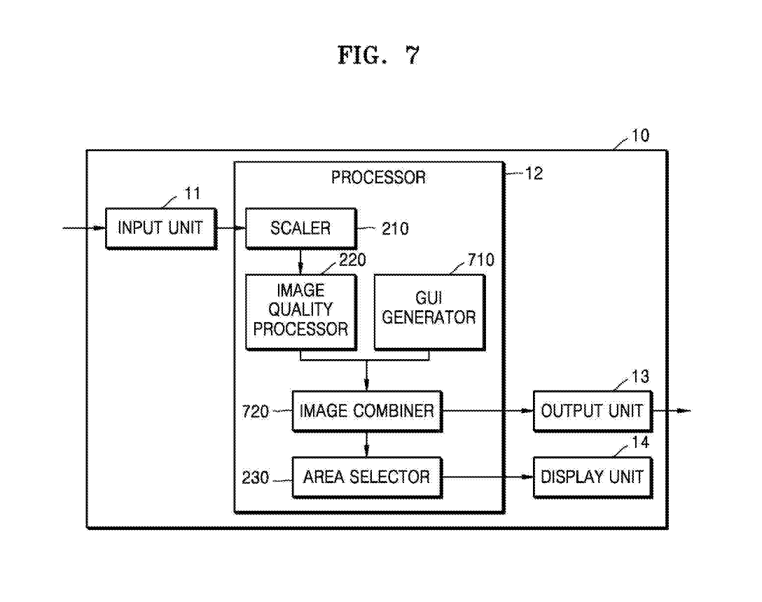

FIG. 7 is a block diagram illustrating another example configuration of the processor 12 of the main display apparatus 10.

Referring to FIG. 7, the processor 12 may further include a graphic user interface (GUI) generator (e.g., processing circuitry configured to provide a GUI generation function) 710 and an image combiner (e.g., processing circuitry configured to provide an image combining function) 720 besides the scaler 210, the image quality processor 220, and the area selector 230.

According to an example embodiment, the GUI generator 710 may be configured to generate a GUI for manipulating the multi display system 100. For example, the GUI generator 710 may generate an on screen display (OSD) menu, a program information window, an Electronic Program Guide (EPG), an application icon, an application window, a user interface (UI) window, a web browser window, or the like but is not limited thereto.

According to an example embodiment, the image combiner 720 may be configured to combine a generated image frame with the GUI based on an image signal that the main display apparatus 10 receives from an external source.

The image combiner 720 may also provide the combined image frame to the output unit 13 and the area selector 230.

According to an example embodiment, the output unit 13 may transmit the combined image frame to at least one sub display apparatus.

According to an example embodiment, the area selector 230 may receive the combined image frame. The area selector 230 may select an area of the combined image frame corresponding to the main display apparatus 10. The selected area may be displayed through the display unit 14.

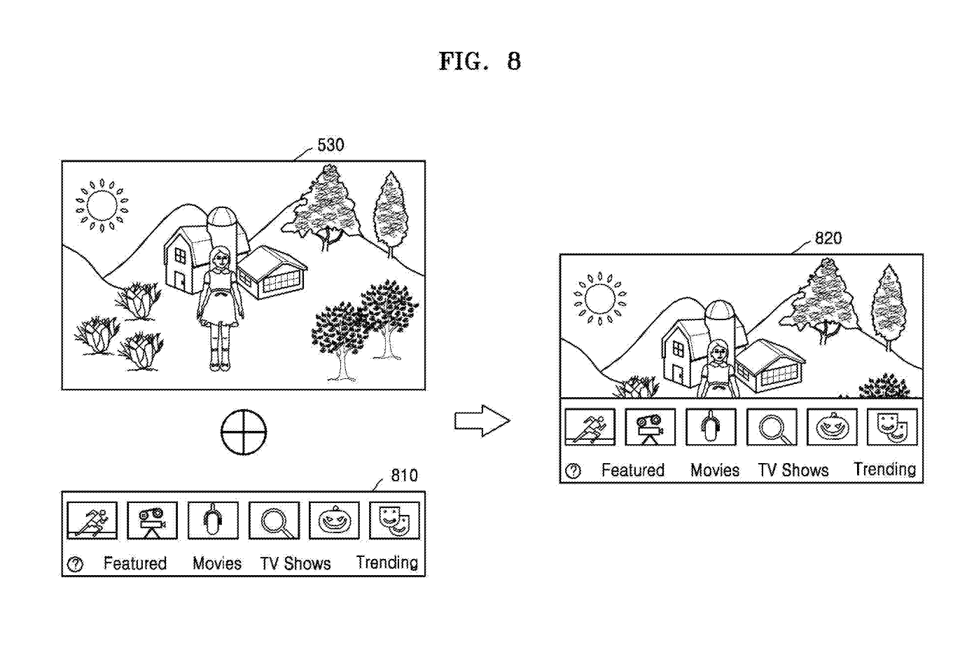

FIG. 8 is a diagram illustrating an example operation of the image combiner 720 of the main display apparatus 10.

Referring to FIG. 8, the image combiner 720 may combine the image frame 530, which is generated based on the image signal received by the main display apparatus 10 from the external source, with an EPG 810 generated by the GUI generator 710 to generate a combined image frame 820. The image combiner 720 may also provide the combined image frame 820 including the EPG 810 to the output unit 13 and the area selector 230.

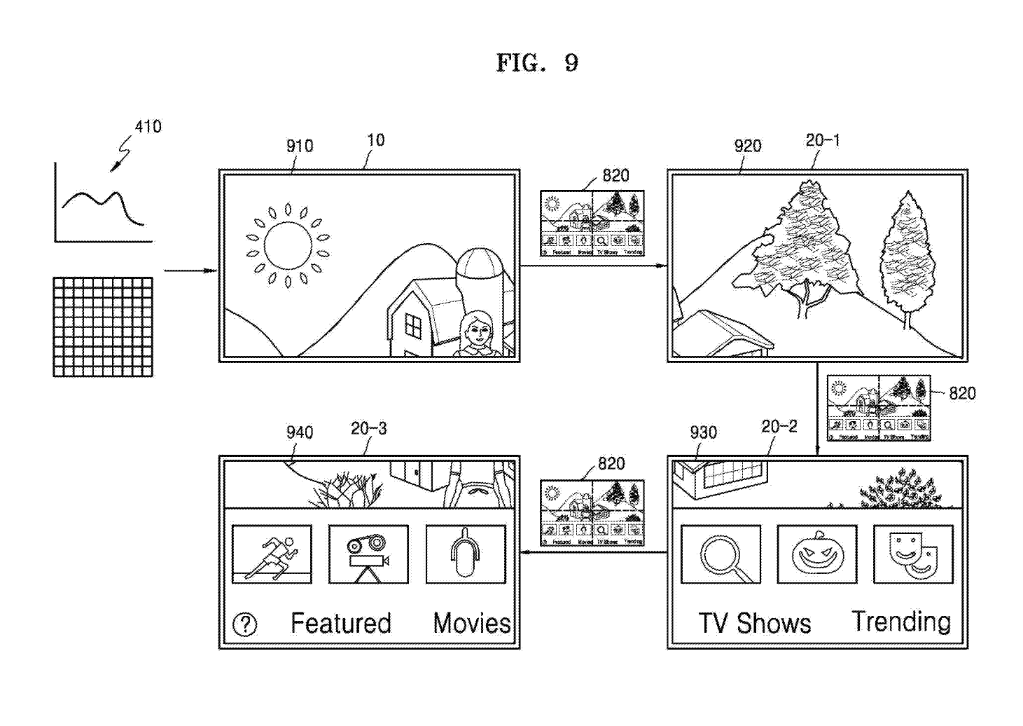

FIG. 9 is a diagram illustrating an example operation of the multi display system 100.

Referring to FIG. 9, the main display apparatus 10 may transmit the combined image frame 820 generated in FIG. 8 to the first sub display apparatus 20-1. The main display apparatus 10 may also display an area 910 of the combined image frame 820 generated in FIG. 8 on a screen of the main display apparatus 10.

As described above with reference to FIG. 6, the first through third sub display apparatuses 20-1 through 20-3 may receive the combined image frame 820 generated by the main display apparatus 10 and transmit the combined image frame 820 to another sub display apparatus. As described with reference to FIG. 6, the first through third sub display apparatuses 20-1 through 20-3 may display areas 920, 930, and 940 of the combined image frame 820 respectively corresponding to the first through third sub display apparatuses 20-1 through 20-3 on screens of the first through third sub display apparatuses 20-1 through 20-3.

As described above, the multi display system 100 according to an example embodiment may display a GUI in an image frame through data processing performed in a main display apparatus. Therefore, a plurality of sub display apparatuses configuring the multi display system 100 may not require additional image-processing.

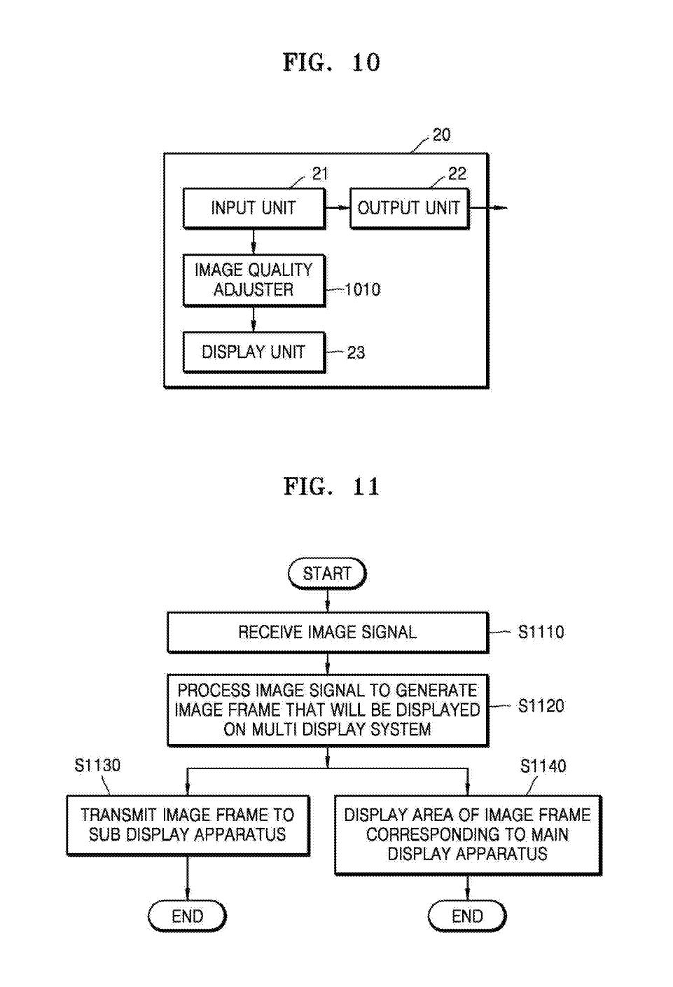

FIG. 10 is a block diagram illustrating an example configuration of the sub display apparatus 20.

Referring to FIG. 10, the sub display apparatus 20 may further include an image quality adjuster (e.g., including image quality adjusting circuitry) 1010 besides the input unit 21, the output unit 22, and the display unit 23 of FIG. 1.

According to an example embodiment, the image quality adjuster 1010 may adjust a display attribute value according to a characteristic of the display unit 23 of the sub display apparatus 20. For example, the display attribute value may be a luminance value or an attribute value of a color necessary for displaying an image frame. For example, the display attribute value may a value of an element of a color such as luminance, chroma, or color (e.g., a red (R) color value, a green (Green) value, a blue (B) color value or the like).

Although display apparatuses include the same types of elements, colors represented on screens may be minutely different according to the display apparatuses. This may occur, for example, because manufacturing environments, distribution environments, and user environments of the display apparatuses are different. Therefore, according to an example embodiment, the sub display apparatus 20 may adjust a display attribute of the sub display apparatus 20 to further clearly provide an image frame generated by the main display apparatus 10.

For example, the image quality adjuster 1010 may simultaneously adjust an R color value, a G color value, and a B color value. In this example, the display unit 23 may display an image frame having corrected luminance. Alternatively, the image quality adjuster 1010 may respectively adjust the R color value, the G color value, and the B color value. In this example, the display unit 23 may display an image frame where a color distortion phenomenon is corrected.

This display attribute value may, for example, be a value between 0 and 255.

FIG. 11 is a flowchart illustrating an example operation method of the main display apparatus 10.

Referring to FIG. 11, in operation S1110, the main display apparatus 10 may receive an image signal. For example, the image signal may include a voice signal. For example, the main display apparatus 10 may receive an image signal, etc. from an external apparatus (e.g., a broadcasting station, a content provider, an external server, or the like).

In operation S1120, the main display apparatus 10 may process the image signal to generate an image frame that will be displayed on the multi display system 100. For example, the multi display system 100 may include the main display apparatus 10 and the plurality of sub display apparatuses 20.

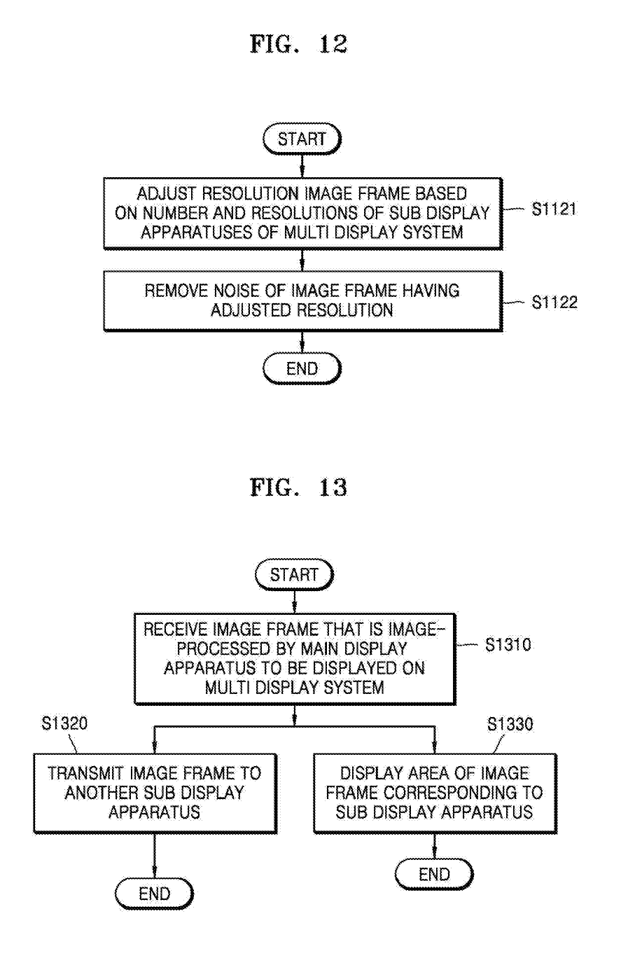

FIG. 12 is a flowchart illustrating example operation S1120 of FIG. 11.

Referring to FIG. 12, in operation S1121, the main display apparatus 10 may adjust a resolution of an image frame based on the number and resolutions of sub display apparatuses 20 included in the multi display system 100. For example, the number of sub display apparatuses 20 may be input by a user of the main display apparatus 10. Alternatively, the number of sub display apparatuses 20 may be acquired through a sensor included in a bezel of the main display apparatus 10. For example, the main display apparatus 10 may acquire the number of sub display apparatuses 20 through a proximity sensor, etc. included in left, right, upper, and lower sides of the main display apparatus 10. Also, a resolution of the sub display apparatus 20 may be a resolution of a display panel of the sub display apparatus 20. According to an example embodiment, the main display apparatus 10 may acquire the resolution of the sub display apparatus 20 from the sub display apparatus 20. Alternatively, the main display apparatus 10 may receive the resolution of the sub display apparatus 20 from the user.

According to an example embodiment, the main display apparatus 10 may determine a resolution of the multi display system 100. The resolution of the multi display system 100 may be a resolution of a final image frame that will be provided through a screen of the main display apparatus 10 and a screen of the sub display apparatus 20.

The main display apparatus 10 may generate an image frame having a determined resolution based on a received image signal. According to an example embodiment, the main display apparatus 10 may be configured to perform up-scaling or down-scaling with respect to the image signal. For example, the main display apparatus 10 may generate an image frame having a higher resolution than a resolution of the image signal through a nearest neighbor interpolation technique, a linear interpolation technique, a bipolar interpolation technique, a spline interpolation technique, a polynomial interpolation technique, or the like. The main display apparatus 10 may generate an image frame having a lower resolution than the resolution of the image signal through a blurring and sub-sampling technique, a median representation technique, or the like.

In operation S1122, the main display apparatus 10 may remove/reduce noise of an image frame having an adjusted resolution. For example, the noise removing/reducing may include, for example, adjusting distorted data included in the image frame. For example, the main display apparatus 10 may perform Gaussian smoothing filtering, box smoothing, median filtering, or the like to remove/reduce the noise included in the image frame.

The main display apparatus 10 may perform contour processing with respect to the image frame. For example, contour processing may include clearing a contour of an object included in the image frame. For example, the main display apparatus 10 may perform a mask technique, a LoG technique, a Canny edge extracting technique, or the like to perform contour processing.

The main display apparatus 10 may correct a boundary distortion phenomenon that may occur at an end point of the image frame but is not limited thereto. In operation S1122, the main display apparatus 10 may perform various types of processing for improving a quality of an image.

Referring to FIG. 11, in operation S1130, the main display apparatus 10 may transmit the image frame to the sub display apparatus 20. According to an example embodiment, the main display apparatus 10 may transmit the image frame having the adjusted resolution and transmit the image frame from which noise is removed/reduced.

According to an example embodiment, the main display apparatus 10 may transmit the image frame to a particular sub display apparatus that is connected to the main display apparatus 10 wirelessly or by a wired connection. In this example, the particular sub display apparatus may transmit the image frame to another sub display apparatus that is connected to the particular sub display apparatus by a wire or wirelessly. Alternatively, the main display apparatus 10 may transmit the image frame to a plurality of sub display apparatuses included in the multi display system 100. In this example, the plurality of sub display apparatuses may not transmit the image frame to another sub display apparatus.

In operation S1140, the main display apparatus 10 may display an area of the image frame corresponding to the main display apparatus 10.

As illustrated in FIGS. 3A and 3B, according to an example embodiment, the main display apparatus 10 of the multi display system 100 may have pre-allocated device number or coordinate values. The main display apparatus 10 may select an area of the image frame based on the pre-allocated device number or coordinate values. Also, the main display apparatus 10 may display the selected area on a screen of the main display apparatus 10.

FIG. 13 is a flowchart illustrating an example operation method of the sub display apparatus 20.

Referring to FIG. 13, in operation S1310, the sub display apparatus 20 may receive an image frame that is image-processed by the main display apparatus 10 to be displayed on the multi display system 100.

In operation S1320, the sub display apparatus 20 may transmit the image frame to another sub display apparatus. For example, the sub display apparatus 20 may transmit the image frame to another sub display apparatus connected to the sub display apparatus 20.

In operation S1330, the sub display apparatus 20 may display an area of the image frame corresponding to the sub display apparatus 20 on a screen.

As illustrated in FIGS. 3A and 3B, according to an example embodiment, the sub display apparatus 20 included in the multi display system 100 may have pre-allocated device number or coordinate values. The sub display apparatus 20 may select an area of the image frame based on the pre-allocated device number or coordinate values. The sub display apparatus 20 may also display the selected area on a screen of the sub display apparatus 20.

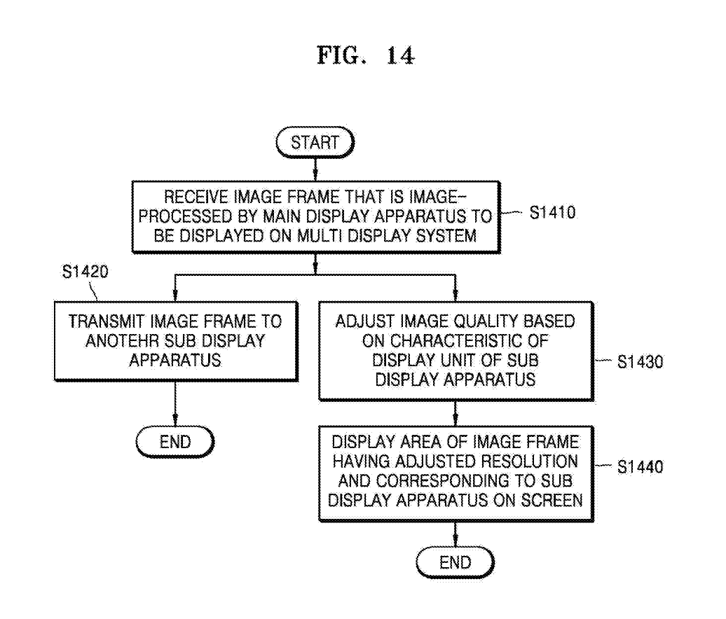

FIG. 14 is a flowchart illustrating an example operation method of the sub display apparatus 20.

Referring to FIG. 14, in operation S1410, the sub display apparatus 20 may receive an image frame that is image-processed by the main display apparatus 10 to be displayed on the multi display system 100. According to an example embodiment, the sub display apparatus 20 may receive the image frame having a resolution adjusted by the main display apparatus 10. Alternatively, the sub display apparatus 20 may receive an image frame from which noise is removed/reduced by the main display apparatus 10.

In operation S1420, the sub display apparatus 20 may transmit the image frame to another sub display apparatus.

In operation S1430, the sub display apparatus 20 may adjust an image quality based on a characteristic of a display unit of the sub display apparatus 20. According to an example embodiment, the sub display apparatus 20 may adjust a display attribute value according to a characteristic of the display unit 23 of the sub display apparatus 20. For example, the display attribute value may be a luminance value or an attribute value of a color necessary for displaying the image frame. For example, the display attribute value may be a value of an element of a color such as luminance, chroma, color (an R color value, a G color value, or B color value), or the like.

For example, the sub display apparatus 20 may simultaneously adjust the R color value, the G color value, and the B color value. In this example, the sub display apparatus 20 may change luminance on a screen. Alternatively, the sub display apparatus 20 may respectively adjust the R color value, the G color value, and the B color value. In this example, the sub display apparatus 20 may correct a color distortion phenomenon on the screen.

In operation S1440, the sub display apparatus 20 may display an area of the image frame, which has an adjusted image quality and corresponds to the sub display apparatus 20, on the screen.

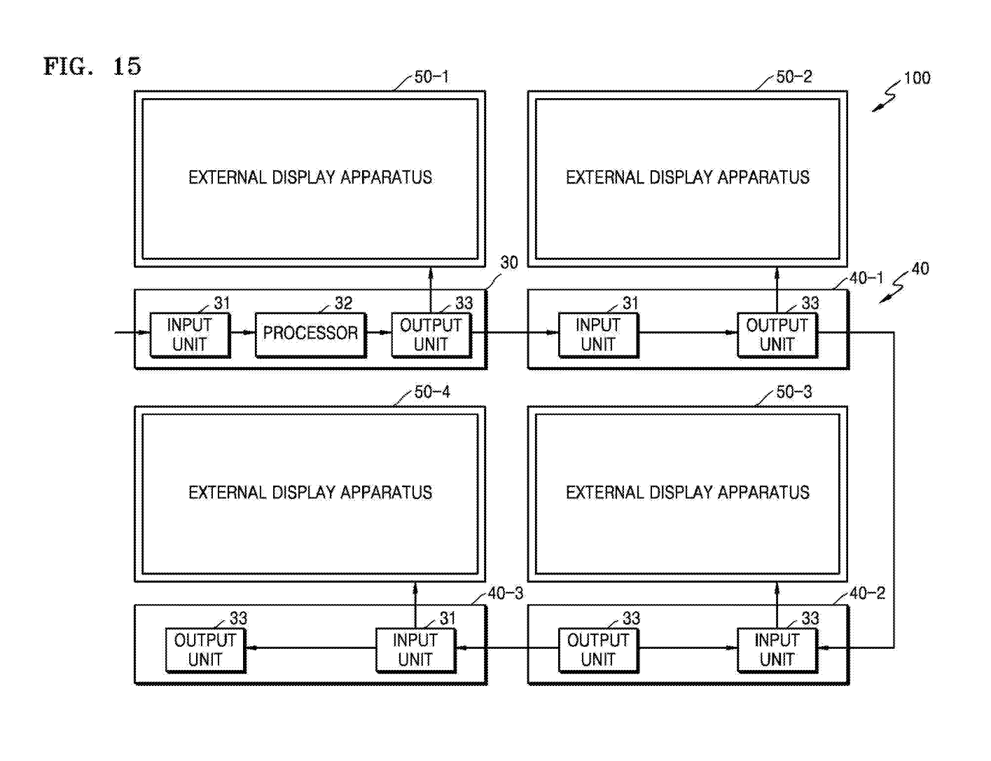

FIG. 15 is a block diagram illustrating another example of multi display system 100.

Referring to FIG. 15, the multi display system 100 may include a main apparatus 30, a plurality of sub apparatuses 40, and a plurality of external display apparatuses 50 connected to the main apparatus 30 or the sub apparatuses 40.

According to an example embodiment, the main apparatus 30 configuring the multi display system 100 may include an input unit 31, a processor 32, and an output unit 33 as described above.

According to an example embodiment, the input unit 31 of the main apparatus 30 may receive an image signal (or data) from an external source. For example, the image signal may include a voice signal. For example, the input unit 31 may receive an image signal from a broadcasting station or may receive an image signal or the like through an internet network. For this, the input unit 31 may include, for example, a short-range communication module (e.g., a Wireless LAN, Wi-Fi, Bluetooth, NFC, or the like), a wired communication module (e.g., pair cable, coaxial cable, optical fiber cable, or the like), a mobile communication module, or the like. A technology of the input unit 31 that receives an image signal through at least one communication module is apparent to those of ordinary kill in the art and thus is omitted.

The input unit 31 may also convert the image signal into a form that may be processed in the main apparatus 30 (e.g., may convert an analog signal into a digital signal). The input unit 31 of the main apparatus 30 may also provide the image signal to the processor 32.

According to an example embodiment, the processor 32 of the main apparatus 30 may process the received image signal to generate an image frame that will be displayed on the multi display system 100. For example, the image frame may be a display data unit that is displayed on the plurality of external display apparatuses 50 of the multi display system 100 for a preset time (e.g. 0.2 seconds). For example, if the plurality of external display apparatuses 50 of the multi display system 100 respectively display images in units of 30 FPS, the main apparatus 30 may generate 30 image frames per second.

According to an example embodiment, it will be easily understood by those of ordinary skill in the art that the processor 32 may include a configuration of the processor 12 of the main display apparatus 10 described above with reference to FIGS. 2 through 7.

According to an example embodiment, the output unit 33 of the main apparatus 30 may transmit the generated image frame to at least one sub apparatus 40. For example, as illustrated in FIG. 15, the output unit 33 of the main apparatus 30 may transmit the image frame to a first sub apparatus 40-1.

The output unit 33 may also transmit the image frame to the external display apparatuses 50 connected to the main apparatus 30. For example, the main apparatus 30 may transmit the image frame to a first external display apparatus 50-1. In this example, the first external display apparatus 50-1 may select an area of the transmitted image frame corresponding to the first external display apparatus 50-1 and display the selected area on a screen.

Alternatively, the output unit 33 may transmit an area of the image frame corresponding to the external display apparatus 50 to the external display apparatus 50 connected to the main apparatus 30. For example, the main apparatus 30 may transmit an area of the image frame to the first external display apparatus 50-1. For example, the processor 32 of the main apparatus 30 may select an area corresponding to the first external display apparatus 50-1.

The output unit 33 may include elements for transmitting and receiving the image frame with at least one sub apparatus 40 and at least one external display apparatus 50. For example, the output unit 33 of the main apparatus 30 may include at least one selected from a short-range communication module and a wired communication module.

According to an example embodiment, the sub apparatus 40 configuring the multi display system 100 may include the input unit 31 and the output unit 33.

According to an example embodiment, the input unit 31 of the sub apparatus 40 may receive an image frame generated by the main apparatus 30. For example, the received image frame may be in a state where a resolution is adjusted. The received image frame may also be in a state where image-processing (e.g., noise removal/reduction, image distortion correction, or the like) is completed by the main apparatus 30. Therefore, the sub apparatus 40 may not include the processor 32 of the main apparatus 30. For example, as illustrated in FIG. 15, the first sub apparatus 40-1 may receive an image frame from the main apparatus 30, and the second sub apparatus 40-2 may receive an image frame generated by the main apparatus 30 from the first sub apparatus 40-1.

The input unit 31 may also include, for example, at least one selected from a short-range communication module (e.g., a Wireless LAN, Wi-Fi, Bluetooth, NFC, or the like) and a wired communication module (e.g., pair cable, coaxial cable, optical fiber cable, or the like). Alternatively, the input unit 31 may include only the wired communication module but is not limited thereto.

The input unit 31 may also transmit the received image frame to the output unit 33 of the sub apparatus 40.

According to an example embodiment, the output unit 33 of the sub apparatus 40 may transmit the image frame provided from the input unit 31 to another sub apparatus. For example, as illustrated in FIG. 15, the first sub apparatus 40-1 may transmit an image frame to the second sub apparatus 40-2, and the second sub apparatus 40-2 may transmit the image frame to a third sub apparatus 40-3. Here, the image frame may be generated by the main apparatus 30.

The output unit 33 may also transmit the image frame generated by the main apparatus 30 to the external display apparatus 50 connected to the sub apparatus 40. In this example, the first external display apparatus 50-1 may select an area of the transmitted image frame corresponding to the first external display apparatus 50-1 and display the selected area on a screen.

Alternatively, the output unit 33 may transmit the area of the image frame corresponding to the first external display apparatus 50-1 to the first external display apparatus 50-1 that is connected to the main apparatus 30 by a wired or wireless connection. For example, the processor 32 of the main apparatus 30 may select the area corresponding to the first external display apparatus 50-1.

The output unit 33 may also include elements for transmitting and receiving the image frame with the external display apparatus 50 and another sub apparatus. For example, the output unit 33 may include at least one selected from a short-range communication module and a wired communication module.

The external display apparatus 50 configuring the multi display system 100 may be realized as various types of display apparatuses such as an LCD, a Cathode Ray Tube (CRT) display, a PDP display, an OLED display, a Field Emission Display (FED), an LED display, a Vacuum Fluorescence Display (VFD), a Digital Light Processing (DLP) display, a Flat Panel Display (FPD), a 3-dimensional (3D) display, a transparent display, etc.

The external display apparatus 50 may also receive an image frame generated by the main apparatus 30 from the main apparatus 30 or the sub apparatus 40. According to an example embodiment, the external display apparatus 50 may select an area of the received image frame corresponding to the external display apparatus 50 and display the selected area on a screen. Alternatively, the external display apparatus 50 may display the received image frame.

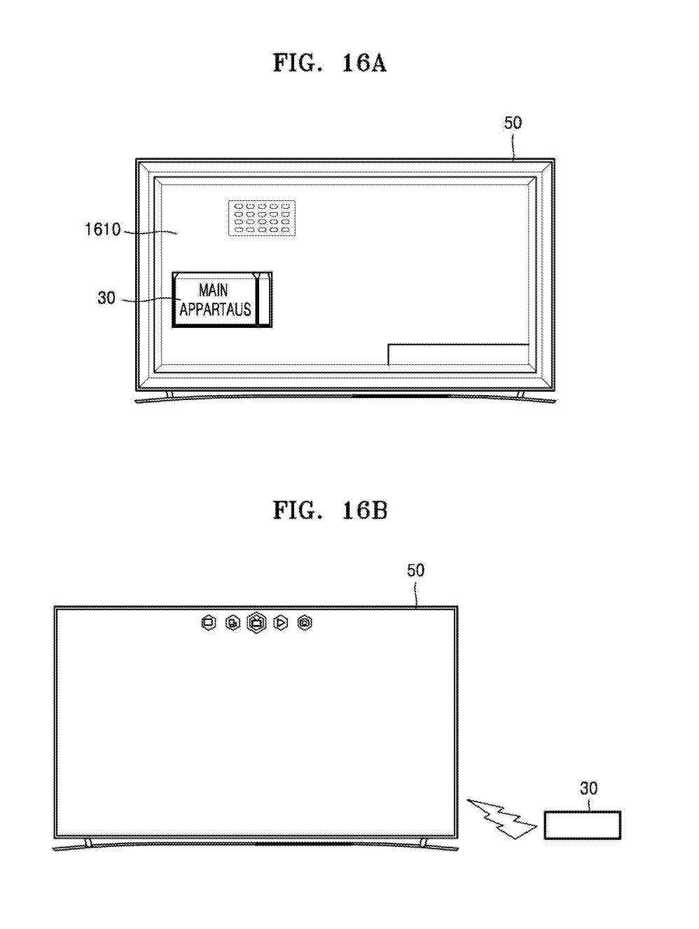

FIGS. 16A and 16B are diagrams illustrating an example connection between the main apparatus 30 and the external display apparatus 50.

Referring to FIG. 16A, the main apparatus 30 may be attached to a back surface 1610 of a housing of the external display apparatus 50 to be formed into a single body so as to communicate with the external display apparatus 50. In this example, the main apparatus 30 and the external display apparatus 50 may be connected to each other by wire.

Referring to FIG. 16B, the main apparatus 30 and the external display apparatus 50 may communicate with each other in a separated state. In this example, the main apparatus 30 may, for example, be a set-top box (STB).

The connection between the main apparatus 30 and the external display apparatus 50 has been described with reference to FIGS. 16A and 16B. However, it will be understood by those of ordinary skill in the art that the connection form may be applied between the sub apparatus 40 and the eternal display apparatus 50.

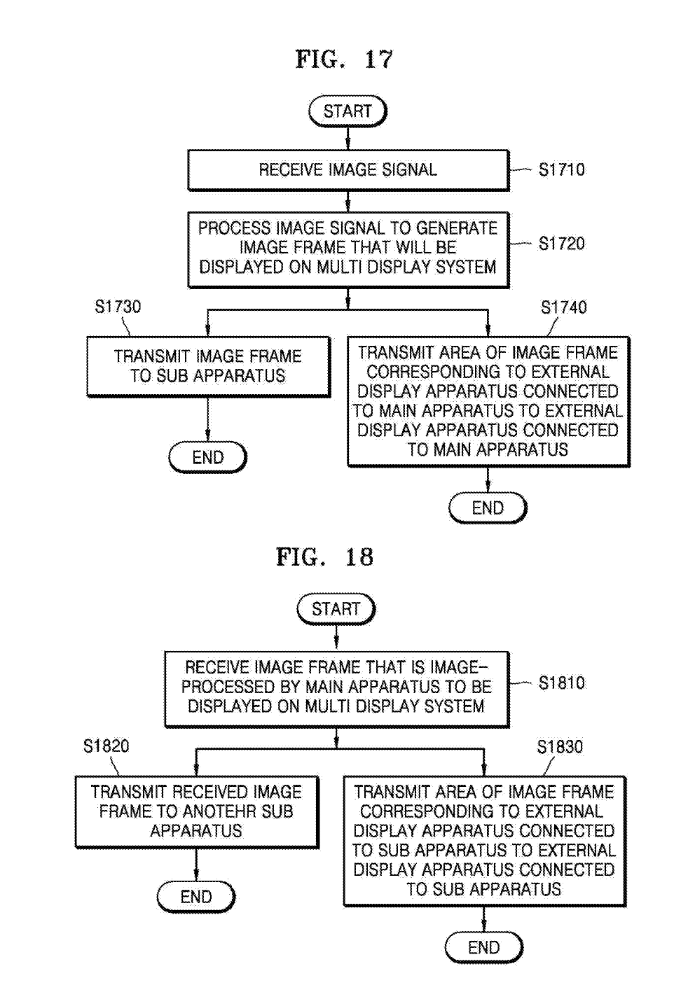

FIG. 17 is a flowchart illustrating an example operation method of the main apparatus 30.

Referring to FIG. 17, in operation S1710, the main apparatus 30 may receive an image signal. For example, the image signal may include a voice signal. For example, the main apparatus 30 may receive an image signal or the like from an external apparatus (e.g., a broadcasting station, a content provider, an external server, or the like).

In operation S1720, the main apparatus 30 may process the image signal to generate an image frame that will be displayed on the multi display system 100. For example, the multi display system 100 may include the main apparatus 30, a plurality of sub apparatuses 40, and a plurality of external display apparatuses 50.

According to an example embodiment, the main apparatus 30 may adjust a resolution of the image frame based on the number and resolutions of the plurality of external display apparatuses 50 of the multi display system 100.

Also, the main apparatus 300 may generate an image frame having a determined resolution based on the received image signal. According to an example embodiment, the main apparatus 30 may perform up-scaling or down-scaling with respect to the image signal.

According to an example embodiment, the main apparatus 30 may remove/reduce noise of the image frame having the adjusted resolution. For example, the noise removing/reducing may include adjusting distorted data included in the image frame.

Also, the main apparatus 30 may perform contour processing with respect to the image frame. For example, the contour processing may clear a contour of an object included in the image frame. The main apparatus 30 may also correct a boundary distortion phenomenon that may occur at an end point of the image frame but is not limited thereto. The main apparatus 30 may perform various types of processing for improving a quality of an image.

In operation S1730, the main apparatus 30 may transmit the image frame to the sub apparatus 40. According to an example embodiment, the main apparatus 30 may transmit the image frame to a particular sub apparatus that is connected to the main apparatus 30 by a wired or wireless connection. Alternatively, the main apparatus 30 may transmit the image frame to a plurality of sub apparatuses of the multi display system 100.

In operation S1740, the main apparatus 30 may transmit an area of the image frame corresponding to the external display apparatus 50 connected to the main apparatus 30 to the external display apparatus 50 connected to the main apparatus 30. Alternatively, the main apparatus 30 may transmit a whole area of the image frame to the external display apparatus 50 connected to the main apparatus 30. In this example, the external display apparatus 50 may select an area of the image frame corresponding to the external display apparatus 50 and display the selected area.

FIG. 18 is a flowchart illustrating an example operation method of the sub apparatus 40.

Referring to FIG. 18, in operation S1810, the sub apparatus 40 may receive an image frame that is image-processed by the main apparatus 30 to be displayed on the multi display system 100.

In operation S1820, the sub apparatus 40 may transmit the received image frame to another sub apparatus.

In operation S1830, the sub apparatus 40 may transmit an area of the image frame corresponding to the external display apparatus 50 connected to the sub apparatus 40 to the external display apparatus 50 connected to the sub apparatus 40. Alternatively, the sub apparatus 40 may transmit a whole area of the image frame to the external display apparatus 50 connected to the sub apparatus 40. In this example, the external display apparatus 50 may select an area of the image frame corresponding to the external display apparatus 50 and display the selected area.

The example embodiments may also be embodied as computer readable codes on a computer readable recording medium. The computer readable recording medium is any data storage device that may store data which may be thereafter read by a computer system.

When the computer readable codes are read and executed from the computer readable recording medium by a processor, the computer readable codes may be configured to perform operations embodying a display method of a display apparatus according to the example embodiments. The computer readable codes may be embodied as various types of programming languages. Also, functional programs, codes, and code segments for accomplishing the embodiments may be easily construed by programmers skilled in the art to which the embodiments pertain.

Examples of the computer readable recording medium include read-only memory (ROM), random-access memory (RAM), CD-ROMs, magnetic tapes, floppy disks, optical data storage devices, etc. The computer readable recording medium may also be distributed over network coupled computer systems so that the computer readable codes are stored and executed in a distributed way.

While one or more example embodiments have been described with reference to the figures, it will be understood by those of ordinary skill in the art that various changes in form and details may be made therein without departing from the spirit and scope as defined by the following claims.

What is claimed is:

1. A main display apparatus of a multi display system comprising:
communication circuitry configured to receive an image signal;
a processor configured to process the image signal to generate an image frame to be displayed on the multi display system, the multi display system comprising the main display apparatus and at least one sub display apparatus, the processor further configured to adjust a resolution of the image frame based on the number and resolution of the at least one sub apparatus, and to control the communication circuitry to transmit the image frame having the adjusted resolution to the at least one sub display apparatus; and
a display configured to display an area of the image frame having the adjusted resolution and corresponding to the main display apparatus.

2. The main display apparatus of claim 1, wherein the processor is configured to reduce noise of the image frame having the adjusted resolution.

3. The main display apparatus of claim 2, wherein the processor further comprises a decoder configured to decode the image signal,
wherein the processor is configured to generate the image frame based on the decoded image signal.

4. The main display apparatus of claim 2, wherein the processor is configured to generate a graphic user interface (GUI) image to be displayed on the main display apparatus and the at least one sub display apparatus, and to combine the GUI image with the image frame.

5. The main display apparatus of claim 4, wherein the communication circuitry is configured to transmit the image frame combined with the GUI image to the at least one sub display apparatus.

6. A sub display apparatus of a multi display system comprising:
communication circuitry configured to receive an image frame from a main display apparatus of the multi display system, the image frame having a resolution adjusted by the main display apparatus to be displayed on a multi display system, the multi display system comprising the main display apparatus and at least one sub display apparatus, the communication circuitry further configured to transmit the image frame having the adjusted resolution to another sub display apparatus of the multi display system; and
a display configured to display an area of the image frame having the adjusted resolution and corresponding to the sub display apparatus.

7. The sub display apparatus of claim 6, further comprising:
image quality processing circuitry configured to adjust an image quality based on a characteristic of the display unit.

8. A multi display system comprising:
a main display apparatus and a plurality of sub display apparatuses, the main display apparatus configured to process an image signal to generate an image frame to be displayed on the multi display system, to adjust a resolution of the image frame based on the number and resolutions of respective sub display apparatuses of the plurality of sub display apparatuses of the multi display system, to transmit the image frame having the adjusted resolution to at least one of the sub display apparatuses, and to display an area of the image frame having the adjusted resolution; and
wherein the plurality of sub display apparatuses are configured to receive the image frame having the resolution adjusted by the main display apparatus and to display an area of the received image frame corresponding to the sub display apparatus.

9. A method of displaying an image on a main display apparatus of a multi display system, comprising:
processing an image signal to generate an image frame to be displayed on a multi display system comprising the main display apparatus and at least one sub display apparatus;
adjusting a resolution of the image frame based on the number and resolutions of respective ones of the at least one sub display apparatuses;
transmitting the image frame having the adjusted resolution to the at least one sub display apparatus; and
displaying an area of the image frame having the adjusted resolution and corresponding to the main display apparatus on the main display apparatus.

10. The method of claim 9, further comprising:
reducing noise of the image frame having the adjusted resolution.

11. The method of claim 9, wherein the generating of the image frame comprises:
generating a GUI image to be displayed on the main display apparatus and the at least one sub display apparatus; and
combining the GUI image with the image frame.

12. The method of claim 11, wherein the transmitting of the image frame to the at least one sub display apparatus comprises transmitting the image frame combined with the GUI image to the at least one sub display apparatus, and the displaying of the area of the image frame on the main display apparatus comprises displaying the area of the image frame being combined with the GUI image and corresponding to the main display apparatus on a screen.

13. A method of displaying an image on a sub display apparatus of a multi display system, comprising:
receiving an image frame having a resolution adjusted by a main display apparatus of the multi display system to enable the image frame to be displayed on the multi display system, the multi display system comprising the main display apparatus and at least one sub display apparatus;
transmitting the image frame having the adjusted resolution to another sub display apparatus of the multi display system; and
displaying an area of the image frame having the adjusted resolution and corresponding to the sub display apparatus on a display corresponding sub display apparatus.

14. The method of claim 13, further comprising:
adjusting an image quality based on a characteristic of a display of the sub display apparatus.
